(19) United States
(12) Patent Application Publication
(10) Pub. No.: US 2010/0054901 A1
(43) Pub. Date: Mar. 4, 2010

(54) Wafer alignment platform

(75) Inventor: Gao-Heng Lin, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/231,120

(22) Filed: Aug. 28, 2008

(51) Int. Cl. B25J 9/10

(52) U.S. Cl. 414/590; 901/27

(57) ABSTRACT

A wafer alignment platform serves to align a wafer so as to make the wafer be carried by a vacuum device that is vertically movable and revolvable. A laser detecting device detects a positioning mark on the wafer and aligns the positioning mark to a directional mark so as to automatically perform center alignment and orientation of the wafer.

### BACKGROUND OF THE INVENTION

1. Technical Field

The present invention relates to devices used in semiconductor processes, and more particularly, to a wafer alignment platform that utilizes a referential notch preformed on a wafer edge to automatically align the wafer.

2. Description of Related Art

In semiconductor processes, automatized devices are usually implemented to load wafers into various reaction/process chambers (hereinafter referred to as the process chambers) to receive processes. A typical automatized device for such application is a robot arm serving to keep accurately transporting wafers. The robot arm is installed in a transportation chamber and capable of getting in and out one or more process chambers adjacent to the transporting chamber. For maximizing the wafer processing efficiency, it is very important to precisely place a wafer at an optimum position in the process chamber. In view of this, precise location of a center of a wafer and accurate orientation of the wafer at its initial position help the robot arm to correctly move the wafer to the process chamber and place the wafer at the optimum position in the process chamber.

According to known arts for determining a location of a center of a wafer and an orientation of the wafer at the wafer's initial position is to manually align a referential notch formed at an edge of the wafer to a directional mark under naked-eye observation. However, this approach tends to suffer from visual errors. Meantime, this approach provides no solution to accurately rotate a wafer to a specific angle for meeting need of subsequent processes. Hence, the conventional approach is not perfect enough to the optimum yield and efficiency of wafer process.

### SUMMARY OF THE INVENTION

One objective of the present invention is to provide a wafer alignment platform that utilizes a referential notch preformed at an edge of a wafer as a positioning mark to automatically align the wafer so as to realize center alignment and full orientation of the wafer on the platform and in turn facilitate a robot arm in correctly moving the wafer to a process chamber and placing the wafer at an optimum position in the process chamber.

To achieve the aforesaid objective, the wafer alignment platform of the present invention comprises:

a vacuum device, serves to hold a wafer on a shaft that is vertically movable and revolvable;

an aligning device that aligns a center of the wafer to a center of the shaft;

a controlling device, driving the shaft to move vertically and revolve; and

a laser detecting device, detecting a positioning mark of the wafer as well as a revolving angle of the wafer and converting the detected positioning mark and revolving angle into electrical signals, wherein the laser detecting device is further coupled with the controlling device so that the controlling device is controlled by the electrical signals.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a wafer alignment platform according to the present invention;

FIG. 2 is a lateral view of the wafer alignment platform according to the present invention;

FIG. 3 is a schematic drawing showing a wafer being aligned on the wafer alignment platform according to the present invention;

FIG. 4 is another schematic drawing showing the wafer being aligned on the wafer alignment platform according to the present invention; and

FIG. 5 is yet another schematic drawing showing the wafer being aligned on the wafer alignment platform according to the present invention.

### DETAILED DESCRIPTION OF THE PREFERRED EMBODIMENTS

While a preferred embodiment is provided herein for illustrating the concept of the present invention as described above, it is to be understood that the components in these drawings are made for better explanation and need not to be made in scale. Moreover, in the following description, resemble components are indicated by the same numerals.

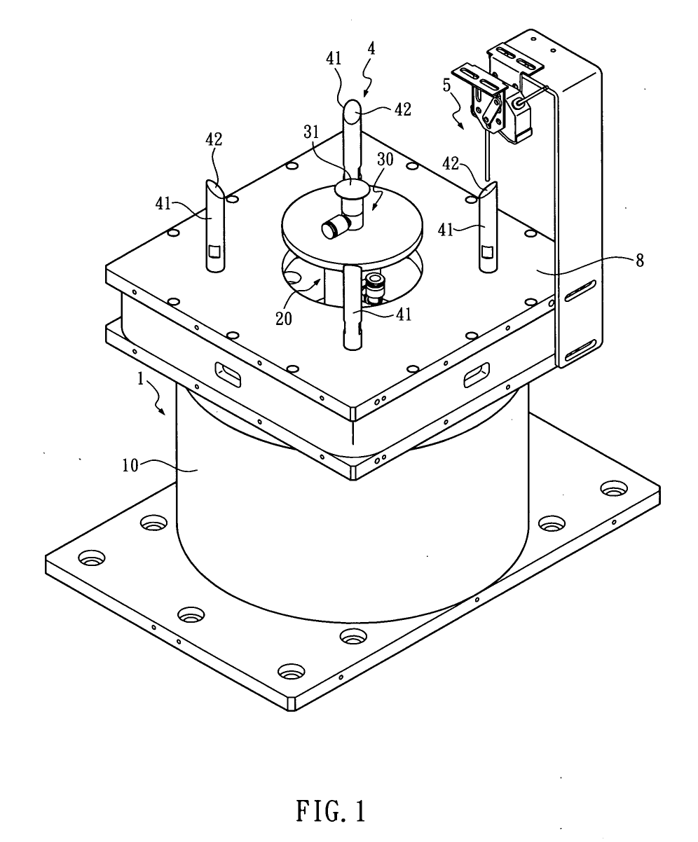

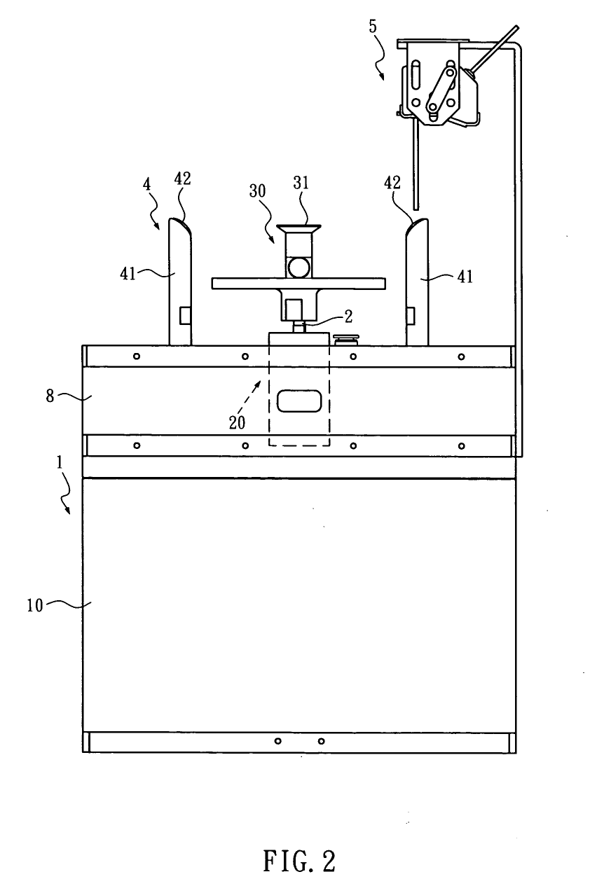

Referring to FIGS. 1, 2 and 3, a wafer alignment platform according to the present invention primarily comprises a vacuum device 30, an aligning device 4, a controlling device 1, and a laser detecting device 5.

The vacuum device 30 serves to hold a wafer 90 on a shaft 2 that is vertically movable and revolvable.

The aligning device 4 serves to align a center of the wafer 90 to a center of the shaft 2.

The controlling device 1 serves to drive the shaft 2 to move vertically and revolve.

The laser detecting device 5 serves to detect a positioning mark as well as a revolving angle of the wafer 90 and convert the detected positioning mark and revolving angle into electrical signals. Furthermore, the laser detecting device 5 is coupled with the controlling device 1 so that the controlling device 1 is controlled to revolve by the electrical signals.

As can be seen in the drawings, the shaft 2, vacuum device 30, aligning device 4, controlling device 1, and the laser detecting device 5 are integrated on a platform 8.

According to the preferred embodiment as shown, the shaft 2 is substantially a cylinder lever of an elevating device 20 such as an air cylinder or a hydraulic cylinder. The controlling device 1 is a torque motor 10. The elevating device 20 is mounted on a driving shaft of the motor 10 so that the driving shaft of the motor 10 drives the elevating device 20 to revolve, thereby making the shaft 2 move vertically or revolve.

The vacuum device 30 provides a sucker 31 that is settled on the shaft 2 for holding the wafer 90. Thereupon, the shaft 2 of the elevating device 20, the motor 10 and the vacuum device 30 jointly move the wafer 90 up and down, and revolve wafer 90 so as to settle the wafer 90 in position.

The aligning device 4 is constructed from a plurality of positioning rods 41 that are erected and arrayed on the platform 8 as a circle surrounding the sucker 31. Each said positioning rod 41 has a top thereof formed as an inclined plane 42 inclined toward a center of the sucker 31 so that the inclined planes 42 of the circularly arrayed positioning rods 41 can fittingly support the wafer 90 at an edge 91 of the wafer 90.

The laser detecting device 5 is settled corresponding to the edge 91 of the wafer 90 for detecting a referential notch preformed on the edge 91 of the wafer 90 as a positioning mark and determining a revolving angle of the wafer 90 basing on the referential notch.

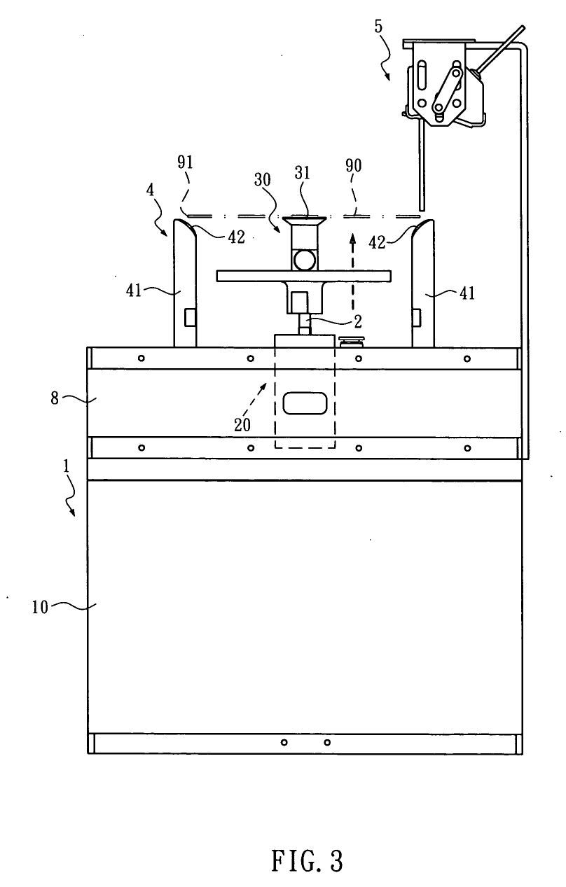

The torque motor 10, elevating device 20, vacuum device 30 and laser detecting device 5 function systematically so as to align the wafer 90 efficiently. The process of wafer alignment will be given below with reference to FIGS. 3 through 5.

As can be seen in FIG. 3, the wafer alignment platform is in a standby state. The elevating device 20 props up the vacuum device 30 and the sucker 31 so as to hold the sucker higher than the tops of the positioning rods 41. A known robot arm places a wafer 90 on the sucker 31 with an obverse side of the wafer 90 upward. At present, the vacuum device 30 is not started and the wafer 90 is not caught by the sucker 31.

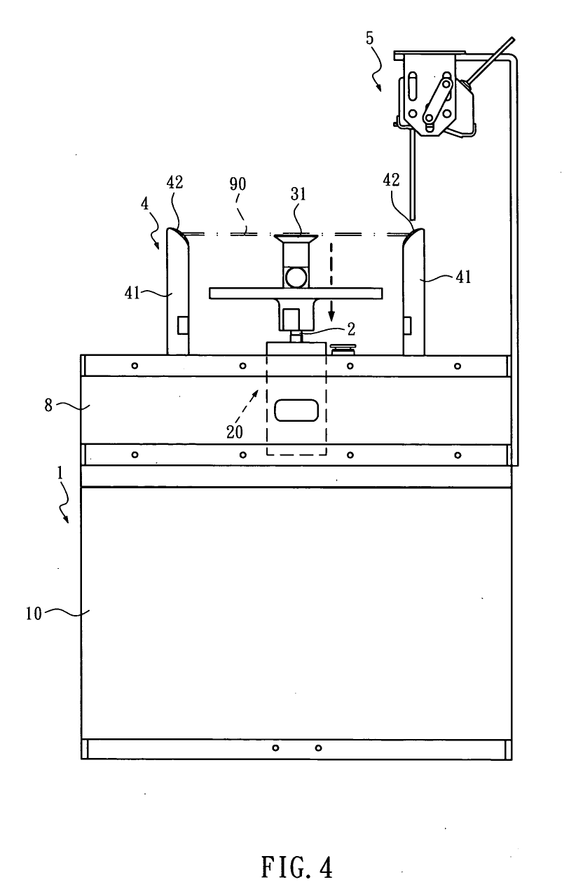

Referring to FIG. 4, the elevating device 20 brings the vacuum device 30 and the sucker 31 downward so that the inclined planes 42 of the circularly arrayed positioning rods 41 support the wafer 90 at its edge 91. Therefore, the centripetally inclined planes 42, in virtue of the gravity, naturally guide the center of the wafer 90 to align to the center of the shaft 2.

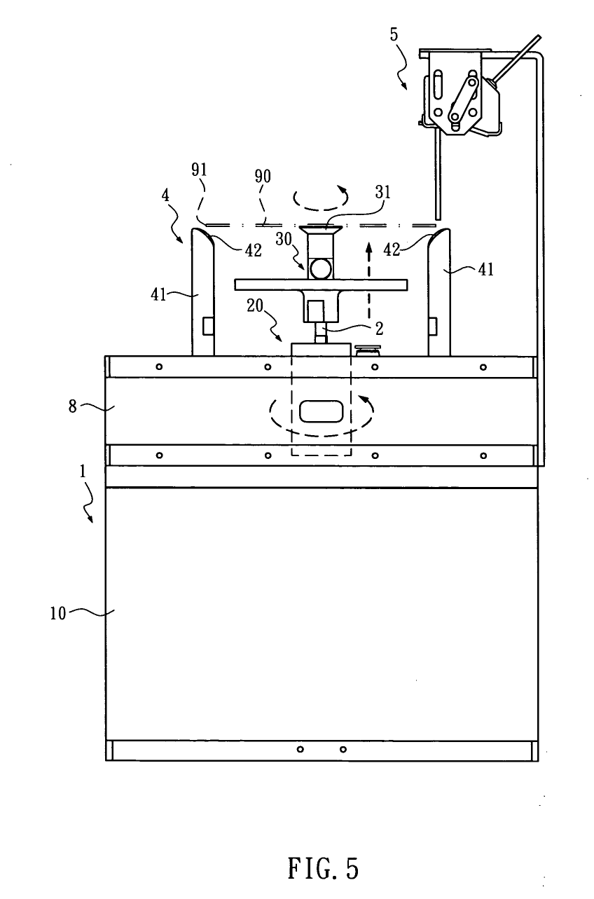

According to FIG. 5, when the vacuum device 30 is started, the sucker 31 catches and holds the wafer 90. The elevating device 20 pushes the wafer 90 upward to holds the wafer 90 higher than the tops of the positioning rods 41. Then the torque motor 10 rotates the elevating device 20 and sucker 31. Afterward, the laser detecting device 5 detects the referential notch at the edge 91 of the wafer 90 and converts the detected data into electrical signals. When receiving the electrical signals, the torque motor 10 stops and thus the wafer alignment process is complete.

At the completion of the wafer alignment process, the vacuum device 30 disables the sucker 31 from catching the wafer 90 so as to allow the robot arm to move the aligned wafer 90 to a process chamber for further processes. Since the wafer has been properly oriented on the wafer alignment platform, the robot arm can correctly move the wafer 90 to the process chamber and rightly place the wafer at the optimum position in the process chamber.

Although the particular embodiment of the invention has been described in detail for purposes of illustration, it will be understood by one of ordinary skill in the art that numerous variations will be possible to the disclosed embodiment without going outside the scope of the invention as disclosed in the claims.

What is claimed is:

1. A wafer alignment platform, comprising:
a vacuum device, holding a wafer on a shaft, wherein the shaft is vertically movable and revolvable;
an aligning device, aligning a center of the wafer to an axis of the shaft;
a controlling device, driving the shaft to move vertically and revolve; and
a laser detecting device, detecting a positioning mark and a revolving angle of the wafer and converting the detected positioning mark and revolving angle into electrical signals, wherein the laser detecting device is further coupled with the controlling device so that the controlling device is controlled by the electrical signals.

2. The wafer alignment platform of claim 1, wherein the shaft, the vacuum device, the wafer center aligning device, the controlling device, and the laser detecting device are integrated on a platform.

3. The wafer alignment platform of claim 2, wherein the controlling device comprises an elevating device and a motor, in which the shaft is a cylinder lever of the elevating device and the motor controls the elevating device and the shaft to revolve.

4. The wafer alignment platform of claim 3, wherein the motor is a torque motor.

5. The wafer alignment platform of claim 2, wherein the vacuum device has a sucker for catching and holding the wafer in position.

6. The wafer alignment platform of claim 5, wherein the vacuum device is mounted on the shaft such that a center of the sucker is vertically corresponding to a center of the shaft.

7. The wafer alignment platform of claim 2, wherein the aligning device comprises a plurality of positioning rods that are erected and arrayed on the platform as a circle surrounding the shaft.

8. The wafer alignment platform of claim 7, wherein each said positioning rod has a top thereof formed as an inclined plane inclined toward a center of the shaft.

9. The wafer alignment platform of claim 2, wherein the laser detecting device is settled corresponding to an edge of the wafer for detecting a referential notch preformed on the edge of the wafer.
